(19) United States
(12) Patent Application Publication
(10) Pub. No.: US 2022/0069309 A1
(43) Pub. Date: Mar. 3, 2022

(54) COMPOSITION FOR LITHIUM BATTERY ELECTRODES

(71) Applicant: SOLVAY SPECIALTY POLYMERS ITALY S.P.A., Bollate (IT)

(72) Inventors: Julio A. ABUSLEME, Saronno (IT); Maurizio BISO, Milano (IT); Riccardo Rino PIERI, Milano (IT)

(21) Appl. No.: 17/422,476

(22) PCT Filed: Feb. 17, 2020
(86) PCT No.: PCT/EP2020/054009

§ 371 Date: Jul. 13, 2021

(30) Foreign Application Priority Data
Feb. 19, 2019 (EP) 19157960.6

(51) Int. Cl. H01M 4/62; H01M 4/36; H01M 4/38; H01M 4/587; H01M 4/04; H01M 4/1395; H01M 4/1393; H01M 10/0525

(52) U.S. Cl. CPC H01M 4/623; H01M 4/625; H01M 4/364; H01M 4/386; H01M 4/587; H01M 2004/027; H01M 4/0409; H01M 4/1395; H01M 4/1393; H01M 10/0525; H01M 4/0404

(57) ABSTRACT

The present invention pertains to an electrode-forming composition, to use of said electrode-forming composition in a process for the manufacture of a composite electrode, to said composite electrode and to a secondary battery comprising said composite electrode.

### CROSS-REFERENCE TO RELATED APPLICATIONS

This application claims priority to European application No. 19157960.6 filed on Feb. 19, 2019, the whole content of those applications being incorporated herein by reference for all purposes.

### TECHNICAL FIELD

The present invention pertains to an electrode-forming composition, to use of said electrode-forming composition in a process for the manufacture of a composite electrode, to said composite electrode and to a secondary battery comprising said composite electrode.

### BACKGROUND ART

Electrochemical devices such as secondary batteries typically comprise a positive electrode, a negative electrode and an electrolyte.

One of the difficulties in manufacturing a secondary battery which is capable of prolonged service-life is to promote and maintain satisfactory contact between the current collector and the face of the electrode adjacent to the current collector. Contact between the interactive surfaces, in particular between the current collector and the face of the electrodes in contact with it, may diminish due to mechanical stresses and loss of cohesion caused by the large volume changes brought about by charging and discharging the battery.

Nowadays, one of the trends in lithium batteries is to enhance their energy capacity by increasing the lithium storage in the anode. For this reason, the conventional graphite anodes enriched with silicon have attracted tremendous interest due to their much higher theoretical energy capacity.

Unfortunately, also silicon suffers from an extremely large volume change that occurs during lithium ion alloying.

The volume change leads to a number of disadvantages. For example, it may cause severe pulverization and break electrical contact between Si particles and carbon conducting agents. It may also cause unstable solid electrolyte interphase (SEI) formation, resulting in degradation of electrodes and rapid capacity fading, especially at high current densities.

Particular attention has been devoted to developing binders that can properly bind the electro-active material particles together and to the metal collector so that these particles can chemically withstand large volume expansion and contraction of the electrodes, and of silicon anodes in particular, during charging and discharging cycles.

Fluoropolymers are known in the art to be suitable as binders for the manufacture of electrodes for use in electrochemical devices such as secondary batteries.

In particular, WO 2008/129041 (SOLVAY SPECIALTY POLYMERS ITALY S.P.A.) discloses linear semi-crystalline vinylidene fluoride copolymers comprising from 0.05% to 10% by moles of recurring units derived from (meth)acrylic monomers and uses thereof as binder in electrodes for lithium-ion batteries.

Also, EP 0793286 AEA TECHNOLOGY PLC 19970903 discloses composite electrodes comprising an electrolyte comprising a vinylidene fluoride polymer grafted with unsaturated monomers comprising one or more groups selected from carboxyl groups, sulphonic acid groups, ester groups and amide groups.

WO 2015/169835 (SOLVAY SA & COMMISSARIAT A L' ENERGIE ATOMIQUE ET AUX ENERGIES ALTERNATIVES) discloses a composite gelled electrode comprising a partially fluorinated fluoropolymer, an electro-active compound and an electrolyte medium.

US 2018/233751 (SOLVAY SA & COMMISSARIAT A L' ENERGIE ATOMIQUE ET AUX ENERGIES ALTERNATIVES & CENTRE NATIONAL DE LA RECHERCHE SCIENTIFIQUE) discloses an electrode forming composition for a lithium battery with good adhesion.

US 2003/113625 (SAMSUNG SDI CO LTD) discloses an electrode comprising an electrode binder comprising a fluorinated polymer and mesophase SiO₂ particles homogenously combined therein, wherein the fluorinated polymer can be PVDF and the mesophase SiO₂ particles are condensation polymerization products of hydrolyzed products of silicon alkoxide compounds such as TEOS.

There is still a need in the art for both positive and negative electrodes which advantageously enable manufacturing electrochemical devices exhibiting outstanding capacity values and good adhesion to metal substrates.

### SUMMARY OF INVENTION

One aim of the present invention is thus to provide a polymer binder that is endowed with good adhesion to metal substrates and can be efficiently used as binder for electrodes of secondary batteries to improve the cycling performances of the same.

It has been now surprisingly found that by using the electrode-forming composition of the invention it is possible to manufacture composite electrodes suitable for use in secondary batteries, said composite electrodes exhibiting high adhesion to metal collectors and high cohesion within the electro-active material while enabling high ionic conductivity in the electrochemical devices thereby provided.

Therefore, a first object of the present invention is an electrode-forming composition [composition (C)] comprising:

(i) a fluoropolymer hybrid organic/inorganic composite [polymer (FH)] obtained by the reaction between:
(i-a) at least one functional partially fluorinated fluoropolymer [polymer (FF)] comprising:
   recurring units derived from at least one fluorinated monomer [monomer (F)] and
   recurring units derived from at least one hydrogenated monomer comprising at least one hydroxyl group [monomer (HM)]; and
(i-b) at least one compound (M) of formula (I):

X₄₋ₘAYₘ (I)

wherein m is an integer from 1 to 4, A is a metal selected from the group consisting of Si, Ti and Zr, Y is a hydrolysable group and X is a hydrocarbon group, optionally comprising one or more functional groups;

(ii) at least one electro-active compound [compound (EA)];

(iii) at least one organic solvent [solvent (S)]; and

(iv) optionally, at least one conductive agent [compound (CA)].

In a second object, the present invention provides a process for the preparation of the composition (C) as defined above, comprising the steps of:

i. providing a mixture of:
(i-a) at least one polymer (FF) as above defined, that comprises recurring units derived from at least one fluorinated monomer [monomer (F)] and recurring units derived from at least one hydrogenated monomer comprising at least one hydroxyl group [monomer (HM)];
(i-b) at least one compound (M) of formula (I):

X₄₋ₘAYₘ (I)

wherein m is an integer from 1 to 4, A is a metal selected from the group consisting of Si, Ti and Zr, Y is a hydrolysable group and X is a hydrocarbon group, optionally comprising one or more functional groups;
(ii) at least one electro-active compound [compound (EA)];
(iii) at least one organic solvent [solvent (S)]; and
(iv) optionally, at least one conductive agent [compound (CA)];

ii. reacting the mixture obtained in step i. thereby providing a composition comprising at least one fluoropolymer hybrid organic/inorganic composite [polymer (FH)].

In another object, the present invention pertains to the use of the composition (C) for the manufacture of a composite electrode [electrode (CE)], said process comprising:

(i) providing a metal substrate having at least one surface;

(ii) providing a composition (C) as above defined;

(iii) applying composition (C) provided in step (ii) onto the at least one surface of the metal substrate provided in step (i), thereby providing an assembly comprising a metal substrate coated with said composition (C) onto the at least one surface;

(iv) drying the assembly provided in step (iii);

(v) optionally submitting the dried assembly obtained in step (iv) to a curing step.

In a further object, the present invention pertains to the composite electrode [electrode (CE)] obtainable by the process of the invention.

In still a further object, the present invention pertains to an electrochemical device comprising a positive electrode and a negative electrode wherein at least one of the positive or the negative electrode is a composite electrode (CE) of the present invention.

The electrode-forming composition (C) of the present invention is particularly suitable for the manufacturing of composite negative electrodes, preferably of silicon negative composite electrodes for electrochemical devices.

### DESCRIPTION OF EMBODIMENTS

For the purpose of the present invention, the term “functional partially fluorinated fluoropolymer” is intended to denote a polymer comprising recurring units derived from at least one fluorinated monomer, wherein at least one of said fluorinated monomers comprise at least one hydrogen atom.

By the term “fluorinated monomer [monomer (F)]” it is hereby intended to denote an ethylenically unsaturated monomer comprising at least one fluorine atom.

By the term “hydrogenated monomer [monomer (H)]” it is hereby intended to denote an ethylenically unsaturated monomer comprising at least one hydrogen atom and free from fluorine atoms.

The term “at least one fluorinated monomer” is understood to mean that the polymer (FF) may comprise recurring units derived from one or more than one fluorinated monomers (F). In the rest of the text, the expression “fluorinated monomers” is understood, for the purposes of the present invention, both in the plural and the singular, that is to say that they denote both one or more than one fluorinated monomers as defined above.

The term “at least one hydrogenated monomer” is understood to mean that the polymer (FF) may comprise recurring units derived from one or more than one hydrogenated monomers (HM). In the rest of the text, the expression “hydrogenated monomers” is understood, for the purposes of the present invention, both in the plural and the singular, that is to say that they denote either one or more than one hydrogenated monomers as defined above.

The polymer (FF) is typically obtainable by polymerization of at least one fluorinated monomer [monomer (F)] and, optionally, at least one hydrogenated monomer [monomer (HM)].

Non limitative examples of suitable monomers (F) include, notably, the followings:
C₂-C₈ perfluoroolefins such as tetrafluoroethylene and hexafluoropropylene;
C₂-C₈ hydrogenated fluoroolefins such as vinylidene fluoride (VDF), vinyl fluoride, 1,2-difluoroethylene and trifluoroethylene (TFE);
perfluoroalkylethylenes of formula CH₂═CH—R_{f0} wherein R_{f0} is a C₁-C₆ perfluoroalkyl;
chloro- and/or bromo- and/or iodo-C₂-C₆ fluoroolefins such as chlorotrifluoroethylene (CTFE);
(per)fluoroalkylvinylethers of formula CF₂═CFOR_{f1} wherein R_{f1} is a C₁-C₆ fluoro- or perfluoroalkyl, e.g. CF₃, C₂F₅, C₃F₇;
CF₂═CFOX₀ (per)fluoro-oxyalkylvinylethers wherein X₀ is a C₁-C₁₂ alkyl group, a C₁-C₁₂ oxyalkyl group or a C₁-C₁₂ (per)fluorooxyalkyl group having one or more ether groups, such as perfluoro-2-propoxy-propyl group;
(per)fluoroalkylvinylethers of formula CF₂═CFOCF₂OR_{f2} wherein R_{f2} is a C₁-C₆ fluoro- or perfluoroalkyl group, e.g. CF₃, C₂F₅, C₃F₇ or a C₁-C₆ (per)fluorooxyalkyl group having one or more ether groups such as —C₂F₅—O—CF₃;
functional (per)fluoro-oxyalkylvinylethers of formula CF₂═CFOY₀ wherein Y₀ is a C₁-C₁₂ alkyl group or (per)fluoroalkyl group, a C₁-C₁₂ oxyalkyl group or a C₁-C₁₂ (per)fluorooxyalkyl group having one or more ether groups and Y₀ comprising a carboxylic or sulfonic acid group, in its acid, acid halide or salt form;
fluorodioxoles, preferably perfluorodioxoles.

The monomer (F) is preferably VDF.

The polymer (FF) comprises preferably at least 0.01% by moles, more preferably at least 0.05% by moles, even more preferably at least 0.1% by moles of recurring units derived from at least one monomer (HM).

The polymer (FF) comprises preferably at most 20% by moles, more preferably at most 15% by moles, even more preferably at most 10% by moles, most preferably at most 3% by moles of recurring units derived from at least one monomer (HM).

Determination of average mole percentage of monomer (HM) recurring units in the polymer (FF) can be performed by any suitable method. Mention can be notably made of acid-base titration methods, well suited e.g. for the determination of the acrylic acid content, of NMR methods, adequate for the quantification of monomers (HM) comprising aliphatic hydrogen atoms in side chains, of weight balance based on total fed monomer (HM) and unreacted residual monomer (HM) during polymer (FF) manufacture.

The monomer (HM) typically comprises at least one hydroxyl group.

The monomer (HM) is preferably selected from the group consisting of (meth)acrylic monomers of formula (II) and vinylether monomers of formula (III):

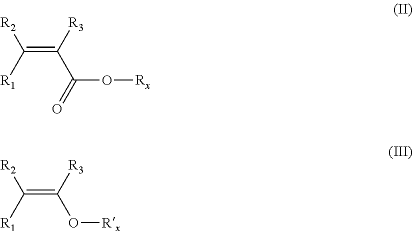

wherein each of R₁, R₂ and R₃, equal to or different from each other, is independently a hydrogen atom or a C₁-C₃ hydrocarbon group, R_{X} and R′ₓ, equal to or different from each other, are a C₁-C₅ hydrocarbon group comprising at least one hydroxyl group.

The monomer (HM) is more preferably of formula (III) as defined above.

Non limitative examples of monomers (HM) include, notably, hydroxyethyl(meth)acrylate, hydroxypropyl(meth)acrylate, hydroxyethylhexyl(meth)acrylate.

The monomer (HM) is even more preferably selected from the followings:
hydroxyethyl acrylate (HEA) of formula:

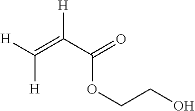

2-hydroxypropyl acrylate (HPA) of either of formulae:

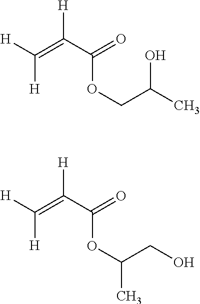

and mixtures thereof.

The polymer (FF) may further include at least one additional fluorinated monomer (FX), different from monomer (F), preferably selected from the group consisting of vinyl fluoride (VF₁), chlorotrifluoroethylene (CTFE), hexafluoropropylene (HFP), tetrafluoroethylene (TFE), trifluoroethylene (TrFE), perfluoromethylvinylether (PMVE).

The polymer (FF) preferably comprises:

(a) at least 60% by moles, preferably at least 75% by moles, more preferably at least 85% by moles of vinylidene fluoride (VDF);

(b) optionally, from 0.1% to 15% by moles, preferably from 0.1% to 12% by moles, more preferably from 0.1% to 10% by moles of at least one monomer (FX) selected from vinyl fluoride (VF₁), chlorotrifluoroethylene (CTFE), hexafluoropropylene (HFP), tetrafluoroethylene (TFE), trifluoroethylene (TrFE), perfluoromethylvinylether (PMVE); and

(c) from 0.01% to 15% by moles, more preferably from 0.05% to 10% by moles, even more preferably from 0.1% to 3% by moles of recurring units derived from at least one monomer (HM).

The polymer (FF) has an intrinsic viscosity, measured in dimethylformamide at 25° C., higher than 0.06 l/g and lower than 0.6 l/g, preferably higher than 0.07 l/g and lower than 0.3 l/g, more preferably higher than 0.09 l/g and lower than 0.15 l/g.

The polymer (FF) is typically obtainable by emulsion polymerization or suspension polymerization according to the methods known to the skilled person in this field.

The metal compound [compound (M)] of formula X₄₋ₘAYₘ can one or more functional groups on any of groups X and Y, preferably on at least one group X.

In case compound (M) comprises at least one functional group, it will be designated as functional compound (M); in case none of groups X and Y comprises a functional group, compound (M) will be designated as non-functional compound (M).

Functional compounds (M) can advantageously provide for a fluoropolymer hybrid organic/inorganic composite having functional groups, thus further modifying the chemistry and the properties of the hybrid composite over native polymer (F) and native inorganic phase.

As non-limitative examples of functional groups, mention can be made of epoxy group, carboxylic acid group (in its acid, ester, amide, anhydride, salt or halide form), sulphonic group (in its acid, ester, salt or halide form), hydroxyl group, phosphoric acid group (in its acid, ester, salt, or halide form), thiol group, amine group, quaternary ammonium group, ethylenically unsaturated group (like vinyl group), cyano group, urea group, organo-silane group, aromatic group.

Preferably, X in compound (M) is selected from C₁-C₁₈ hydrocarbon groups, optionally comprising one or more functional groups. More preferably, X in compound (M) is a C₁-C₁₂ hydrocarbon group, optionally comprising one or more functional group.

Functional group of compound (M) is preferably selected among carboxylic acid group (in its acid, anhydride, salt or halide form), sulfonic group (in its acid, salt or halide form), phosphoric acid group (in its acid, salt, or halide form), amine group, and quaternary ammonium group; most preferred will be carboxylic acid group (in its acid, anhydride, salt or halide form) and sulphonic group (in its acid, salt or halide form).

The selection of the hydrolysable group Y of the compound (M) is not particularly limited, provided that it enables in appropriate conditions the formation of a —O-A≡ bond; said hydrolysable group can be notably a halogen (especially a chlorine atom), a hydrocarboxy group, a acyloxy group or a hydroxyl group.

Preferably, the metal A in compound (M) of formula (I) is Si, and compound (M) is an alkoxysilane; more preferably, compound (M) is tetramethoxysilane (TMOS), tetraethoxysilane (TEOS), 3-(triethoxysilyl)propylisocyanate (TSPI) or mixtures thereof. Most preferably, the compound (M) is a mixture of TSPI and TEOS.

Examples of functional compounds (M) are notably vinyltriethoxysilane, vinyltrimethoxysilane, vinyltrismethoxyethoxysilane of formula CH₂═CHSi(OC₂H₄OCH₃)₃,

2-(3,4-epoxycyclohexylethyltrimethoxysilane) of formula:

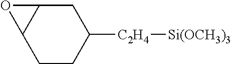

glycidoxypropylmethyldiethoxysilane of formula:

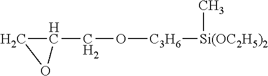

glycidoxypropyltrimethoxysilane of formula:

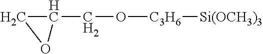

methacryloxypropyltrimethoxysilane of formula:

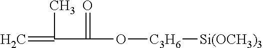

aminoethylaminpropylmethyldimethoxysilane of formula:

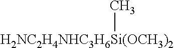

aminoethylaminpropyltrimethoxysilane of formula:

H₂NC₂H₄NHC₃H₆Si(OCH₃)₃

3-aminopropyltriethoxysilane, 3-phenylaminopropyltrimethoxysilane, 3-chloroisobutyltriethoxysilane, 3-chloropropyltrimethoxysilane, 3-mercaptopropyltriethoxysilane, 3-mercaptopropyltrimethoxysilane, n-(3-acryloxy-2-hydroxypropyl)-3-aminopropyltriethoxysilane, (3-acryloxypropyl)dimethylmethoxysilane, (3-acryloxypropyl)methyldichlorosilane, (3-acryloxypropyl)methyldimethoxysilane, 3-(n-allylamino)propyltrimethoxysilane, 2-(4-chlorosulfonylphenyl)ethyltrimethoxysilane, 2-(4-chlorosulphonylphenyl)ethyl trichlorosilane, carboxyethylsilanetriol, and its sodium salts, triethoxysilylpropylmaleamic acid of formula:

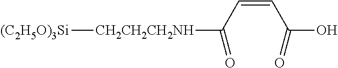

3-(trihydroxysilyl)-1-propane-sulphonic acid of formula HOSO₂—CH₂CH₂CH₂—Si(OH)₃, N-(trimethoxysilylpropyl)ethylene-diamine triacetic acid, and its sodium salts, 3-(triethoxysilyl)propylsuccinic anhydride of formula:

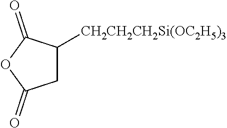

acetamidopropyltrimethoxysilane of formula H₃C—C(O)NH—CH₂CH₂CH₂—Si(OCH₃)₃, alkanolamine titanates of formula Ti(A)_{X}(OR)_{Y}, wherein A is an amine-substituted alkoxy group, e.g. OCH₂CH₂NH₂, R is an alkyl group, and x and y are integers such that x+y=4.

Examples of non-functional compounds (M) are notably triethoxysilane, trimethoxysilane, tetramethyltitanate, tetraethyltitanate, tetra-n-propyltitanate, tetraisopropyltitanate, tetra-n-butyltitanate, tetra-isobutyl titanate, tetra-tert-butyl titanate, tetra-n-pentyltitanate, tetra-n-hexyltitanate, tetraisooctyltitanate, tetra-n-lauryl titanate, tetraethylzirconate, tetra-n-propylzirconate, tetraisopropylzirconate, tetra-n-butyl zirconate, tetra-sec-butyl zirconate, tetra-tert-butyl zirconate, tetra-n-pentyl zirconate, tetra-tert-pentyl zirconate, tetra-tert-hexyl zirconate, tetra-n-heptyl zirconate, tetra-n-octyl zirconate, tetra-n-stearyl zirconate.

In the context of the present invention, the term “fluoropolymer hybrid” indicates a composition comprising an organic/inorganic network formed by grafting the inorganic domains deriving from compound (M) with the hydroxyl groups deriving from monomer (HM).

Grafting the inorganic domains deriving from compound (M) with the hydroxyl groups deriving from monomer (HM) is achieved by reaction of the said compound (M) and the said polymer (FF) in the presence of an acid catalyst, wherein the inorganic domains deriving from hydrolysis and polycondensation of compound (M) are at least partially chemically bound to polymer (FF) via reaction with hydroxyl groups deriving from monomer (HM).

The amount of inorganic domains deriving from compound (M) included in the organic/inorganic network of the fluoropolymer hybrid composite polymer (FH) is calculated assuming complete conversion of compound (M) included in the composition (C) to the corresponding product of hydrolysis and polycondensation.

The amount of the compound (M) in composition (C) is advantageously of at least 0.1% by weight, preferably at least 1% by weight, more preferably at least 5% by weight of said compound (M) based on the total weight of the polymer (FF) and the compound (M) in said composition.

The amount of the compound (M) in composition (C) is advantageously of at most 95% by weight, preferably at most 75% by weight, more preferably at most 55% by weight of said compound (M) based on the total weight of the polymer (FF) and the compound (M) in said composition.

For the purpose of the present invention, the term “electro-active compound [compound (EA)]” is intended to denote a compound which is able to incorporate or insert into its structure and substantially release therefrom alkaline or alkaline-earth metal ions during the charging phase and the discharging phase of an electrochemical device. The compound (EA) is preferably able to incorporate or insert and release lithium ions.

The nature of the compound (EA) in composition (C) depends on whether said composition is used in the manufacture of a positive composite electrode [electrode (CEp)] or a negative composite electrode [electrode (CEn)].

In the case of forming a positive composite electrode (CEp) fora Lithium-ion secondary battery, the compound (EA) may comprise a composite metal chalcogenide of formula LiMQ₂, wherein M is at least one metal selected from transition metals such as Co, Ni, Fe, Mn, Cr and V and Q is a chalcogen such as O or S. Among these, it is preferred to use a lithium-based composite metal oxide of formula LiMO₂, wherein M is the same as defined above. Preferred examples thereof may include LiCoO₂, LiNiO₂, LiNiₓCo₁₋ₓO₂ (0<x<1) and spinel-structured LiMn₂O₄.

As an alternative, still in the case of forming a positive composite electrode (CEp) for a Lithium-ion secondary battery, the compound (EA) may comprise a lithiated or partially lithiated transition metal oxyanion-based electro-active material of formula M₁M₂(JO₄)_{f}E_{1-f}, wherein M₁ is lithium, which may be partially substituted by another alkali metal representing less than 20% of the M₁ metals, M₂ is a transition metal at the oxidation level of +2 selected from Fe, Mn, Ni or mixtures thereof, which may be partially substituted by one or more additional metals at oxidation levels between +1 and +5 and representing less than 35% of the M₂ metals, including 0, JO₄ is any oxyanion wherein J is either P, S, V, Si, Nb, Mo or a combination thereof, E is a fluoride, hydroxide or chloride anion, f is the molar fraction of the JO₄ oxyanion, generally comprised between 0.75 and 1.

The M₁M₂(JO₄)_{f}E_{1-f} electro-active material as defined above is preferably phosphate-based and may have an ordered or modified olivine structure.

More preferably, the compound (EA) in the case of forming a positive composite electrode (CEp) has formula Li₃₋ₓM′_{y}M″_{2-y}(JO₄)₃ wherein 0≤x≤3, 0≤y≤2, M′ and M″ are the same or different metals, at least one of which being a transition metal, JO₄ is preferably PO₄ which may be partially substituted with another oxyanion, wherein J is either S, V, Si, Nb, Mo or a combination thereof. Still more preferably, the compound (EA) is a phosphate-based electro-active material of formula Li(FeₓMn₁₋ₓ)PO₄ wherein 0≤x≤1, wherein x is preferably 1 (that is to say, lithium iron phosphate of formula LiFePO₄).

In the case of forming a negative composite electrode (CEn) for a Lithium-ion secondary battery, the compound (EA) may preferably comprise a carbon-based material and/or a silicon-based material.

In some embodiments, the carbon-based material may be, for example, graphite, such as natural or artificial graphite, graphene, or carbon black.

These materials may be used alone or as a mixture of two or more thereof.

The carbon-based material is preferably graphite.

The silicon-based compound may be one or more selected from the group consisting of chlorosilane, alkoxysilane, aminosilane, fluoroalkylsilane, silicon, silicon chloride, silicon carbide and silicon oxide. More particularly, the silicon-based compound may be silicon oxide or silicon carbide.

When present in compound (EA), the at least one silicon-based compound is comprised in the compound (EA) in an amount ranging from 1 to 30% by weight, preferably from 5 to 20% by weight with respect to the total weight of the compound (EA).

The organic solvent (S) may preferably be a polar one, examples of which may include: N-methyl-2-pyrrolidone, N,N-dimethylformamide, N,N-dimethylacetamide, dimethylsulfoxide, hexamethylphosphamide, dioxane, tetrahydrofuran, tetramethylurea, triethyl phosphate, and trimethyl phosphate. These organic solvents may be used singly or in mixture of two or more species.

An optional conductive agent may be added in order to improve the conductivity of a resulting composite electrode (CE).

Examples thereof may include: carbonaceous materials, such as carbon black, graphite fine powder carbon nanotubes, graphene, or fiber, or fine powder or fibers of metals such as nickel or aluminum. The optional conductive agent is preferably carbon black. Carbon black is available, for example, under the brand names, Super P® or Ketjenblack®.

When present, the conductive agent is different from the carbon-based material described above.

In one embodiment of the present invention, the electrode-forming composition [composition (C)] may further include at least one additional fluoropolymer [polymer (FB)], different from polymer (FF), which comprises recurring units derived from at least one fluorinated monomer [monomer (MF)] as below defined.

The polymer (FB) is preferably a partially fluorinated fluoropolymer.

For the purpose of the present invention, the term “partially fluorinated fluoropolymer” is intended to denote a polymer comprising recurring units derived from at least one fluorinated monomer, wherein at least one of said fluorinated monomers comprise at least one hydrogen atom.

By the term “fluorinated monomer (MF)” it is hereby intended to denote an ethylenically unsaturated monomer comprising at least one fluorine atom.

The term “at least one fluorinated monomer (MF)” is understood to mean that the polymer (FB) may comprise recurring units derived from one or more than one fluorinated monomers (MF).

The monomer (MF) is generally selected from the group consisting of:

(a) C₂-C₈ perfluoroolefins, such as tetrafluoroethylene, and hexafluoropropene;

(b) C₂-C₈ hydrogenated fluoroolefins, such as vinyl fluoride, 1,2-difluoroethylene, vinylidene fluoride and trifluoroethylene;

(c) perfluoroalkylethylenes complying with formula CH₂═CH—R_{f0}, in which R_{f0} is a C₁-C₆ perfluoroalkyl;

(d) chloro- and/or bromo- and/or iodo-C₂-C₆ fluoroolefins, like chlorotrifluoroethylene;

(e) (per)fluoroalkylvinylethers complying with formula CF₂═CFOR_{f1} in which R_{f1} is a C₁-C₆ fluoro- or perfluoroalkyl, e.g. CF₃, C₂F₅, C₃F₇;

(f) CF₂═CFOX₀ (per)fluoro-oxyalkylvinylethers, in which X₀ is a C₁-C₁₂ alkyl, or a C₁-C₁₂ oxyalkyl, or a C₁-C₁₂ (per)fluorooxyalkyl having one or more ether groups, like perfluoro-2-propoxy-propyl;

(g) (per)fluoroalkylvinylethers complying with formula CF₂═CFOCF₂OR_{f2} in which R_{f2} is a C₁-C₆ fluoro- or perfluoroalkyl, e.g. CF₃, C₂F₅, C₃F₇ or a C₁-C₆ (per)fluorooxyalkyl having one or more ether groups, like —C₂F₅—O—CF₃;

(h) functional (per)fluoro-oxyalkylvinylethers complying with formula CF₂═CFOY₀, in which Y₀ is a C₁-C₁₂ alkyl or (per)fluoroalkyl, or a C₁-C₁₂ oxyalkyl, or a C₁-C₁₂ (per)fluorooxyalkyl having one or more ether groups and Y₀ comprising a carboxylic or sulfonic acid group, in its acid, acid halide or salt form;

(i) fluorodioxoles, of formula (I):

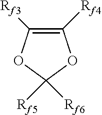

wherein each of R_{f3}, R_{f4}, R_{f5}, R_{f6}, equal or different each other, is independently a fluorine atom, a C₁-C₆ fluoro- or per(halo)fluoroalkyl, optionally comprising one or more oxygen atom, e.g. —CF₃, —C₂F₅, —C₃F₇, —OCF₃, —OCF₂CF₂OCF₃.

According to an embodiment of the invention, the polymer (FB) is a partially fluorinated fluoropolymer comprising recurring units derived from vinylidene fluoride (VDF), and, optionally, recurring units derived from at least one fluorinated monomer different from VDF.

Polymer (FB) may suitably further contain recurring units derived from at least one hydrophilic (meth)acrylic monomer (MA) of formula (IV):

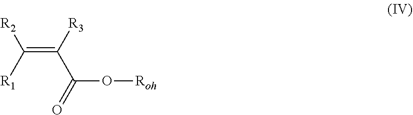

wherein:
R₁, R₂ and R₃, equal to or different from each other, are independently selected from a hydrogen atom and a C₁-C₃ hydrocarbon group, and

R_{OH} is a hydrogen atom or a C₁-C₅ hydrocarbon moiety comprising at least one carboxylic group.

(Meth)acrylic monomer (MA) is preferably acrylic acid.

The polymer (FB) of this preferred embodiment of the invention more preferably comprises:
at least 95% by moles of recurring units derived from vinylidene fluoride (VDF),
from 0.5% to 5.0% by moles, preferably from 1.5 to 4.5% by moles, more preferably from 1.5% to 3.0% by moles, even more preferably from 2.0 to 3.0% by moles of recurring units derived from at least one fluorinated monomer different from VDF,
from 0.05% to 2% by moles, preferably from 0.1 to 1.2% by moles, more preferably from 0.2 to 1.0% by moles of at least one hydrophilic (meth)acrylic monomer (MA),

all the aforementioned % by moles being referred to the total moles of recurring units of the polymer (FB).

The said fluorinated monomer different from VDF is advantageously selected from vinyl fluoride (VF1), chlorotrifluoroethylene (CTFE), hexafluoropropylene (HFP), tetrafluoroethylene (TFE), trifluoroethylene (TrFE) and perfluoromethylvinylether (PMVE).

The polymer (FB) has an intrinsic viscosity, measured in dimethylformamide at 25° C., higher than 0.25 l/g, preferably higher than 0.30 l/g, more preferably higher than 0.35 l/g.

The polymer (FB) is typically obtainable by emulsion polymerization or suspension polymerization.

Polymer (FB) may be present in composition (C) in an amount of up to 50% by weight based on the total amount of polymer (FF) and polymer (FB).

Composition (C) as defined above can be suitably prepared by the process as above defined.

In step i. of the process for the preparation of composition (C), at least one polymer (FB) may be further added to the mixture in an amount suitable to obtain the composition (C) as above defined.

Step ii. may preferably be performed in the presence of an acid catalyst.

The selection of the acid catalyst in step ii. is not particularly limited.

The acid catalyst is typically selected from the group consisting of organic and inorganic acids.

The acid catalyst is typically added to the mixture provided in step i. in an amount comprised between 0.5% and 10% by weight, preferably between 1% and 5% by weight, based on the total weight of said mixture.

The acid catalyst is preferably selected from the group consisting of organic acids.

Very good results have been obtained with formic acid.

In step ii. the reaction is usually carried out at room temperature or upon heating at a temperature lower than 100° C. The temperature will be selected having regards to the boiling point of the solvent (S) present in composition (C). Temperatures between 20° C. and 90° C., preferably between 20° C. and 50° C. will be preferred.

As this will be recognized by the skilled in the art, the reaction in step ii. usually generates low molecular weight side products, which can be notably water or alcohols, as a function of the nature of the compound (M).

The mixture provided in step i. as above detailed, is preferably obtained by first dissolving 0.1-15 wt. parts, particularly 5-10 wt. parts, of the polymer (FF) in 100 wt. parts of such an organic solvent, followed by addition of compound (M), the electrode-active compound (EA) in powdery form and, optionally, the conductive agent (CA) and optional additives such as a viscosity modifying agent, and possibly by diluting the resulting composition with additional solvent.

The conductive agent may be added in order to improve the conductivity of a resultant composite electrode (CE) formed by applying and drying of the electrode-forming composition of the present invention, particularly in case of preparing a positive composite electrode (CEp) using an active substance, such as LiCoO₂ or LiFePO₄, showing a limited electron-conductivity. Examples thereof may include: carbonaceous materials, such as carbon black, graphite fine powder and fiber, and fine powder and fiber of metals, such as nickel and aluminum.

The amount of polymer (FF) in the electrode composition depends on the properties of the carbon-based material and of the silicon-based compound used in the electrode-active compound (EA) and of the conductive agent optionally present in the composition (C).

The electrode-forming composition (C) of the invention can be used in a process for the manufacture of a composite electrode [electrode (CE)], said process comprising:

(i) providing a metal substrate having at least one surface;

(ii) providing a composition (C) as above defined;

(iii) applying composition (C) provided in step (ii) onto the at least one surface of the metal substrate provided in step (i), thereby providing an assembly comprising a metal substrate coated with said composition (C) onto the at least one surface;

(iv) drying the assembly provided in step (iii);

(v) optionally submitting the dried assembly obtained in step (iv) to a curing step.

The metal substrate is generally a foil, mesh or net made from a metal, such as copper, aluminium, iron, stainless steel, nickel, titanium or silver.

Under step (iii) of the process of the invention, the composition (C) is applied onto at least one surface of the metal substrate typically by any suitable procedures such as casting, printing and roll coating.

Optionally, step (iii) may be repeated, typically one or more times, by applying the composition (C) provided in step (ii) onto the assembly provided in step (iv).

Curing in step (v) of the process is suitably carried out by submitting the dried assembly obtained in step (iv) to a thermal treatment at a temperature of at least 130° C., preferably of at least 150° C., for at least 30 minutes.

It is understood that the hydrolysis and/or condensation reaction started in step ii. of the process for the preparation of composition (C) may be continued during any one of steps (iii) to (v) of the process of the invention for preparing the composite electrode (CE).

The dried assembly obtained at step (iv) or the cured assembly obtained at step (v) may be further subjected to a compression step, such as a calendaring process, to achieve the target porosity and density of the electrode (CE).

Preferably, the dried assembly obtained at step (iv) or the cured assembly obtained at step (v) is hot pressed, the temperature during the compression step being comprised from 25° C. and 130° C., preferably being of about 90° C.

Preferred target porosity for electrode (CE) is comprised between 15% and 40%, preferably from 25% and 30%. The porosity of electrode (CE) is calculated as the complementary to unity of the ratio between the measured density and the theoretical density of the electrode, wherein:
the measured density is given by the mass divided by the volume of a circular portion of electrode having diameter equal to 24 mm and a measured thickness; and
the theoretical density of the electrode is calculated as the sum of the product of the densities of the components of the electrode multiplied by their mass ratio in the electrode formulation.

In a further instance, the present invention pertains to the composite electrode [electrode (CE)] obtainable by the process of the invention.

The electrode (CE) of the invention typically comprises:
a metal substrate, and
directly adhered onto at least one surface of said metal substrate, at least one layer [layer (L1)] consisting of a composition (C) comprising:
   (i) a fluoropolymer hybrid organic/inorganic composite [polymer (FH)] obtained by the reaction between:
      (i-a) at least one functional partially fluorinated fluoropolymer [polymer (FF)] comprising:
recurring units derived from at least one fluorinated monomer [monomer (F)] and
recurring units derived from at least one hydrogenated monomer comprising at least one hydroxyl group [monomer (HM)];
   (i-b) at least one compound (M) of formula (I):

X₄₋ₘAYₘ (I)
wherein m is an integer from 1 to 4, A is a metal selected from the group consisting of Si, Ti and Zr, Y is a hydrolysable group and X is a hydrocarbon group, optionally comprising one or more functional groups;
   (ii) at least one electro-active compound [compound (EA)];
   (iii) at least one organic solvent [solvent (S)]; and
   (iv) optionally, at least one conductive agent [compound (CA)].

In a preferred embodiment, the compound (EA) comprises a carbon-based material and/or a silicon-based material, and the electrode (CE) is a negative composite electrode [electrode (nCE)], preferably a silicon negative composite electrode.

The silicon negative composite electrode generally comprises:
graphite in an amount by weight of from 75% to 95%, preferably from 85% to 90%;
at least one silicon compound in an amount by weigh of from 3% to 20%, preferably of from 5% to 10%;
a conductive agent in an amount by weight of from 0% to 5%, preferably from 0.5% to 2.5%, more preferably of about 1%;
polymer (FF) in an amount by weight of from 1% to 15%, preferably from 5% to 10%;
the percentages by weight being indicated with respect to the total weight of the electrode.

The Applicant has surprisingly found that the composite electrode (CE) of the present invention shows good adhesion of the binder to current collector, better capacity retention and better capacity towards conventional silicon negative electrode binders.

The composite electrode (CE) of the invention is particularly suitable for use in electrochemical devices, in particular in secondary batteries.

For the purpose of the present invention, the term “secondary battery” is intended to denote a rechargeable battery.

The secondary battery of the invention is preferably an alkaline or an alkaline-earth secondary battery.

The secondary battery of the invention is more preferably a Lithium-ion secondary battery.

An electrochemical device according to the present invention can be prepared by standard methods known to a person skilled in the art.

Should the disclosure of any patents, patent applications, and publications which are incorporated herein by reference conflict with the description of the present application to the extent that it may render a term unclear, the present description shall take precedence.

The invention will be now described with reference to the following examples, whose purpose is merely illustrative and not intended to limit the scope of the invention.

Experimental Part

Raw Materials

Silicon/carbon, commercially available as BTR 450-B from BTR: it is a mixture of Si and graphite. The theoretical capacity is 450 mAh/g.

According to this capacity value, the Si content can be estimated to be around 7% wt.

Carbon black, commercially available as SC45 and SC65, both from Imerys S.A.

NMP (N-Methyl-2-Pyrrolidone) solvent commercially available from Sigma Aldrich.

Tetraethylorthosilicate (TEOS) commercially available as liquid from Aldrich Chemistry purity >99%.

Carboxymethylcellulose (CMC), commercially available as MAC 500LC from Nippon Paper.

Styrene-Butadiene Rubber (SBR) water dispersion 40% by weight, commercially available as Zeon® BM-480B from ZEON Corporation.

NMC622 HX12Th commercially available from Umicore.

Polymer (FF-1): VDF/HEA (0.6% by Moles)/HFP (2.5% by Mole) Polymer Having an Intrinsic Viscosity of 0.097 l/g in DMF at 25° C.

In a 80 lt. reactor equipped with an impeller running at a speed of 250 rpm were introduced in sequence 49992 g of demineralised water and 15.2 g of METHOCEL® K100 GR suspending agent. The reactor was purged with sequence of vacuum (30 mmHg) and purged of nitrogen at 20° C. Then 204.4 g of a 75% by weight solution of t-amyl perpivalate initiator in isododecane. The speed of the stirring was increased at 300 rpm. Finally, 20.4 g of hydroxyethylacrylate (HEA) and 2555 g of hexafluoropropylene (HFP) monomers were introduced in the reactor, followed by 22735 g of vinylidene fluoride (VDF) were introduced in the reactor. The reactor was gradually heated until a set-point temperature at 55° C. and the pressure was fixed at 120 bar. The pressure was kept constantly equal to 120 bars by feeding 16.9 kg of aqueous solution containing a 235 g of HEA during the polymerization. After this feeding, no more aqueous solution was introduced and the pressure started to decrease until 90 bar. Then, the polymerization was stopped by degassing the reactor until reaching atmospheric pressure. In general a conversion around 76% of monomers was obtained. The polymer so obtained was then recovered, washed with demineralised water and oven-dried at 65° C.

Polymer (FF-2): VDF/HEA (0.4% by Moles)/HFP (2.5% by Moles) Copolymer Having an Intrinsic Viscosity of 0.114 l/g in DMF at 25° C.

Polymer (FF-2) is manufactured in similar way as Polymer (FF-1).

Polymer (A): VDF-AA (0.6% by Moles)-HFP (0.8% by Moles) Polymer Having an Intrinsic Viscosity of 0.38 l/g in DMF at 25° C.

In a 80 litres reactor equipped with an impeller running at a speed of 250 rpm were introduced, in sequence, 24.5 Kg of demineralised and 0.6 g/kgMnT of hydroxyethylcellulose derivative (suspending agent, commercially available as Bermocoll® E 230 FQ from AkzoNobel), wherein g/MnT means grams of product per Kg of the total amount of the comonomers (HFP, AA and VDF) introduced during the polymerization. The reactor was purged with sequence of vacuum (30 mmHg) and purged of nitrogen at 20° C. Then 2.65 g/kgMnT of a 75% by weight solution of t-amyl-perpivalate in isododecane (initiator agent, commercially available from Arkema) was added. The speed of the stirring was increased at 300 rpm. Finally, 8.5 g of acrylic acid (AA) and 0.85 Kg of hexafluoropropylene (HFP) were introduced in the reactor, followed by 24.5 Kg of vinylidene fluoride (VDF).

The reactor was gradually heated until the set-point temperature at 50° C. and the pressure was fixed at 120 bar. The pressure was kept constantly equal to 120 bar by feeding 204 g of AA diluted in an aqueous solution (concentration of AA of 12.5 g/Kg water). After this feeding, no more aqueous solution was introduced and the pressure started to decrease. Then, the polymerization was stopped by degassing the reactor until reaching atmospheric pressure. In general a conversion between around 74% and 85% of comonomers was obtained. The polymer so obtained was then recovered, washed with demineralised water and oven-dried at 65° C.

General Procedure for the Manufacture of Electrodes

Electrodes were prepared by mixing the components as detailed below by using the following equipment:
mechanical mixer: planetary mixer (Speedmixer) and mechanical mixer of the Dispermat® series with flat PTFE lightweight dispersion impeller (for good mixing dispersion state),
film coater/Doctor Blade: Elcometer 4340 Motorised/Automatic Film Applicator,
vacuum oven: vacuum drying oven—BINDER APT line VD 53 with vacuum,
roll press: Precision 4″ Hot Rolling Press/Calender up to 100° C.

### Example 1: Negative Electrode According to the Invention (Polymer (FF-1))

An NMP composition was prepared by mixing at 500 rpm 16.25 g of a 8% by weight solution of Polymer (FF-1) in NMP, 0.19 g of TEOS, 24.4 g of silicon/carbon mixture and 0.26 g of SC45 and 11.05 g of NMP.

The mixture was mixed by moderate stirring at 1000 rpm for 1 h, then 0.08 g of formic acid was added and the mixture mixed for 1 additional minute giving the binder composition.

A negative electrode was obtained by casting the binder composition so obtained on a 20 um thick copper foil with a doctor blade and drying the coating layer so obtained in an oven at temperature ramp from 80° C. to 130° C. for about 60 minutes. The negative electrode was then cured at 150° C. for 40 minutes.

The thickness of the dried coating layer was about 90 μm.

The electrode was then hot pressed at 90° C. in a roll press to achieve the target porosity (30%).

The negative electrode so obtained (electrode (E1)) had the following composition: 93.8% by weight of silicon/carbon, 5% by weight of binder, 1% by weight of carbon black and 0.2% by weight of SiO₂. The weight ratio binder/SiO₂ is 96/4.

### Example 2: Negative Electrode According to the Invention (Blend Polymer (FF-1)/Polymer (A)=60/40)

An NMP composition was prepared by mixing at 500 rpm 9.75 g of a 8% by weight solution of Polymer (FF-1) in NMP, 6.5 g of a 8% by weight solution of Polymer (A) in NMP, 0.19 g of TEOS, 24.4 g of silicon/carbon mixture and 0.26 g of SC45 and 11.05 g of NMP.

The mixture was mixed by moderate stirring at 1000 rpm for 1 h, then 0.08 g of formic acid was added and the mixture mixed for 1 additional minute giving the binder composition.

A negative electrode was obtained by casting the binder composition so obtained on a 20 um thick copper foil with a doctor blade and drying the coating layer so obtained in an oven at temperature ramp from 80° C. to 130° C. for about 60 minutes. The negative electrode was then cured at 150° C. for 40 minutes.

The thickness of the dried coating layer was about 90 μm.

The electrode was then hot pressed at 90° C. in a roll press to achieve the target porosity (30%).

A negative electrode was so obtained (electrode (E2)).

### Comparative Example 3: Negative Electrode (SBR/CMC)

An aqueous composition was prepared by mixing 29.17 g of a 2% by weight solution of CMC, in water, 5.25 g of deionized water, 32.9 g of silicon/carbon and 0.35 g of carbon black.

The mixture was homogenized by moderate stirring.

After about 1 h of mixing, 2.33 g of SBR suspension was added to the composition and mixed again at low stirring for 1 h, giving the binder composition.

A negative electrode was obtained casting the binder composition so obtained on a 20 um thick copper foil with a doctor blade and drying the coating layer so obtained in an oven at temperature of 60° C. for about 60 minutes.

The thickness of the dried coating layer was about 90 μm.

The electrode was then hot pressed at 60° C. in a roll press to achieve target porosity (30%).

The negative electrode so obtained (electrode (Comp E3)) had the following composition: 94% by weight of silicon/carbon, 1.66% by weight of CMC, 3.33% by weight of SBR, and 1% by weight of carbon black.

Adhesion Properties Measurement on the Negative Electrodes

Peeling tests were performed on electrode (E1), electrode (E2) and electrode (Comp E3) by following the standard ASTM D903 at a speed of 300 mm/min at 20° C. in order to evaluate the adhesion of the electrode composition coating on the metal foil.

The results are reported in Table 1.

The results show that electrodes (E1 and E2) according to the present invention have good values of adhesion to the copper current collector, higher than that of the benchmark electrode (Comp E3).

TABLE 1

| | Adhesion |
|---|---|
| | (N/m) |
| E1 | 14.5 |
| E2 | 55.5 |
| Comp E3 | 10 |

Manufacture of Batteries

Lithium coin cells (CR2032 type) were prepared in a glove box under Ar gas atmosphere by punching a small disk of the electrode prepared according to Example 1 and 2 and Comparative Example (Comp E3) together with Lithium metal as counter electrode. The electrolyte used in the preparation of the coin cells was a standard 1M LiPF₆ in the binary solvents of EC:DMC=1:1 in % by weight, commercially available from BASF as LP30, with 2% by weight of VC and 10% by weight of F1EC as additive; polyethylene separators (commercially available from Tonen Chemical Corporation) were used as received.

After initial charge and discharge cycles at a low current rate, each of the two cells was galvanostatically cycled at a constant current rate of C/10-D/10. As seen from the data in Table 2, the cells using anode E1 and E2 exhibited a similar good value of coulombic efficiency, and lower capacity fade with cycling, compared to the cell using anode of Example Comp E3. It has been found that higher capacity is maintained for the coin cell comprising the negative electrode of the invention in comparison with that comprising the other electrode (Comp E3).

TABLE 2

| | Coulombic | | Capacity retention | | Capacity retention | |
|---|---|---|---|---|---|---|
| | efficiency at | Initial | after 25 cycles | | after 50 cycles | |
| | first cycle | discharge | | % of the initial | | % of the initial |
| | % | (mAh/g) | (mAh/g) | capacity | (mAh/g) | capacity |
| E1 | 88 | 410 | 375 | 91.7 | 363.5 | 88.9 |
| E2 | 87 | 446.5 | 396 | 89 | 376 | 84.3 |
| Comp E3 | 88 | 447 | 379 | 85 | 268 | 60 |

### Example 4: Positive Electrode According to the Invention (Polymer (FF-1))

An NMP composition was prepared by pre-mixing for 10 minutes in a speedmixer 22.75 g of a 8% by weight solution of Polymer (FF-1) in NMP, 0.27 g of TEOS, 87.4 g of NMC, 1.82 g of SC65 and 28.07 g of NMP.

The mixture was mixed by moderate stirring at 1000 rpm for 1 h, then 0.112 g of formic acid was added and the mixture mixed for 1 additional minute giving the binder composition.

A positive electrode was obtained by casting the binder composition so obtained on a 10 um thick Al foil with a doctor blade and drying the coating layer so obtained in an oven at temperature of 90° C. for about 70 minutes.

The positive electrode was then cured at 150° C. for 40 minutes.

The thickness of the dried coating layer was about 102 μm.

The positive electrode so obtained (electrode (E4)) had the following composition: 95.9% by weight of NMC, 2% by weight of binder, 2% by weight of carbon black and 0.1% by weight of SiO₂. The weight ratio binder/SiO₂ is 96/4.

### Example 5: Positive Electrode According to the Invention (Blend Polymer (FF-1)/Polymer (A)=60/40)

An NMP composition was prepared by pre-mixing for 10 minutes in a speedmixer 13.65 g of a 8% by weight solution of Polymer (FF-1) in NMP, 9.1 g of a 8% by weight solution of Polymer (A), 0.27 g of TEOS, 87.4 g of NMC, 1.82 g of SC65 and 28.07 g of NMP.

The mixture was mixed by moderate stirring at 1000 rpm for 1 h, then 0.112 g of formic acid was added and the mixture mixed for 1 additional minute giving the binder composition.

A positive electrode was obtained by casting the binder composition so obtained on a 10 um thick Al foil with a doctor blade and drying the coating layer so obtained in an oven at temperature of 90° C. for about 70 minutes.

The positive electrode was then cured at 150° C. for 40 minutes.

The thickness of the dried coating layer was about 96 μm.

A positive electrode was so obtained (electrode (E5)).

In view of the above, it has been found that the composition (C) of the present invention and any electrodes prepared thereof is particularly suitable for use in the preparation of binders for silicon negative electrodes for use in secondary batteries having improved performance.

1-16. (canceled)

17. An electrode-forming composition [composition (C)] comprising:
(i) a fluoropolymer hybrid organic/inorganic composite [polymer (FH)] obtained by the reaction between:
(i-a) at least one functional partially fluorinated fluoropolymer [polymer (FF)] comprising:
recurring units derived from at least one fluorinated monomer [monomer (F)] and
recurring units derived from at least one hydrogenated monomer comprising at least one hydroxyl group [monomer (HM)];
(i-b) at least one compound (M) of formula (I):
X₄₋ₘAYₘ (I)
wherein m is an integer from 1 to 4, A is a metal selected from the group consisting of Si, Ti and Zr, Y is a hydrolysable group and X is a hydrocarbon group, optionally comprising one or more functional groups;
(ii) at least one electro-active compound [compound (EA)];
(iii) at least one organic solvent [solvent (S)]; and
(iv) optionally, at least one conductive agent [compound (CA)].

18. The composition (C) according to claim 17, wherein monomer (F) is selected from the group consisting of:
C₂-C₈ perfluoroolefins;
C₂-C₈ hydrogenated fluoroolefins;
perfluoroalkylethylenes of formula CH₂═CH—R_{f0} wherein R_{f0} is a C₁-C₆ perfluoroalkyl;
chloro- and/or bromo- and/or iodo-C₂-C₆ fluoroolefins;
(per)fluoroalkylvinylethers of formula CF₂═CFOR_{f1} wherein R_{f1} is a C₁-C₆ fluoro- or perfluoroalkyl;
CF₂═CFOX₀ (per)fluoro-oxyalkylvinylethers wherein X₀ is a C₁-C₁₂ alkyl group, a C₁-C₁₂ oxyalkyl group or a C₁-C₁₂ (per)fluorooxyalkyl group having one or more ether groups;
(per)fluoroalkylvinylethers of formula CF₂═CFOCF₂OR_{f2} wherein R_{f2} is a C₁-C₆ fluoro- or perfluoroalkyl group;
functional (per)fluoro-oxyalkylvinylethers of formula CF₂═CFOY₀ wherein Y₀ is a C₁-C₁₂ alkyl group or (per)fluoroalkyl group, a C₁-C₁₂ oxyalkyl group or a C₁-C₁₂ (per)fluorooxyalkyl group having one or more ether groups and Y₀ comprising a carboxylic or sulfonic acid group, in its acid, acid halide or salt form;
fluorodioxoles.

19. The composition (C) according to claim 17, wherein monomer (HM) is selected from the group consisting of (meth)acrylic monomers of formula (II) and vinylether monomers of formula (III): 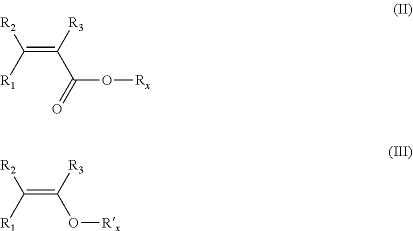
wherein each of R₁, R₂ and R₃, equal to or different from each other, is independently a hydrogen atom or a C₁-C₃ hydrocarbon group, R_{X} and R′ₓ, equal to or different from each other, are a C₁-C₅ hydrocarbon group comprising at least one hydroxyl group.

20. The composition (C) according to claim 17, which further includes at least one additional fluoropolymer [polymer (FB)], different from polymer (FF), said polymer (FB) comprising:
recurring units derived from at least one fluorinated monomer [monomer (MF)] selected from the group consisting of:
(a) C₂-C₈ perfluoroolefins;
(b) C₂-C₈ hydrogenated fluoroolefins;
(c) perfluoroalkylethylenes complying with formula CH₂═CH—R_{f0}, in which R_{f0} is a C₁-C₆ perfluoroalkyl;
(d) chloro- and/or bromo- and/or iodo-C₂-C₆ fluoroolefins;
(e) (per)fluoroalkylvinylethers complying with formula CF₂═CFOR_{f1} in which R_{f1} is a C₁-C₆ fluoro- or perfluoroalkyl;
(f) CF₂═CFOX₀ (per)fluoro-oxyalkylvinylethers, in which X₀ is a C₁-C₁₂ alkyl, or a C₁-C₁₂ oxyalkyl, or a C₁-C₁₂ (per)fluorooxyalkyl having one or more ether groups;
(g) (per)fluoroalkylvinylethers complying with formula CF₂═CFOCF₂OR_{f2} in which R_{f2} is a C₁-C₆ fluoro- or perfluoroalkyl;
(h) functional (per)fluoro-oxyalkylvinylethers complying with formula CF₂═CFOY₀, in which Y₀ is a C₁-C₁₂ alkyl or (per)fluoroalkyl, or a C₁-C₁₂ oxyalkyl, or a C₁-C₁₂ (per)fluorooxyalkyl having one or more ether groups and Y₀ comprising a carboxylic or sulfonic acid group, in its acid, acid halide or salt form;
(i) fluorodioxoles, of formula (I): 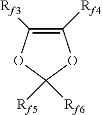
wherein each of R_{f3}, R_{f4}, R_{f5}, R_{f6}, equal or different each other, is independently a fluorine atom, a C₁-C₆ fluoro- or per(halo)fluoroalkyl, optionally comprising one or more oxygen atom; and
recurring units derived from at least one hydrophilic (meth)acrylic monomer (MA) of formula (IV): 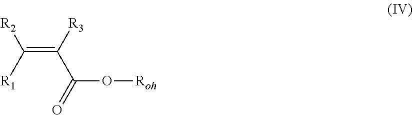
wherein:
R₁, R₂ and R₃, equal to or different from each other, are independently selected from a hydrogen atom and a C₁-C₃ hydrocarbon group, and
R_{OH} is a hydrogen atom or a C₁-C₅ hydrocarbon moiety comprising at least one hydroxyl group.

21. The composition (C) according to claim 20, wherein polymer (FB) comprises:
at least 95% by moles of recurring units derived from vinylidene fluoride (VDF),
from 0.5% to 5.0% by moles, preferably from 1.5 to 4.5% by moles of recurring units derived from at least one fluorinated monomer different from VDF,
from 0.05% to 2% by moles of at least one hydrophilic (meth)acrylic monomer (MA), all the aforementioned % by moles being referred to the total moles of recurring units of the polymer (FB).

22. The composition (C) according to claim 17 wherein compound (M) is an alkoxysilane or a mixture of a mixture of two or more of the following: tetramethoxysilane (TMOS), tetraethoxysilane (TEOS), and 3-(triethoxysilyl)propylisocyanate (TSPI).

23. A process for the preparation of the composition (C) according to claim 17, said process comprising the steps of:
i. providing a mixture of:
(i-a) at least one polymer (FF) as above defined, that comprises recurring units derived from at least one fluorinated monomer [monomer (F)] and recurring units derived from at least one hydrogenated monomer comprising at least one hydroxyl group [monomer (HM)];
(i-b) at least one compound (M) of formula (I):
X₄₋ₘAYₘ (I)
wherein m is an integer from 1 to 4, A is a metal selected from the group consisting of Si, Ti and Zr, Y is a hydrolysable group and X is a hydrocarbon group, optionally comprising one or more functional groups;
(ii) at least one electro-active compound [compound (EA)];
(iii) at least one organic solvent [solvent (S)]; and
(iv) optionally, at least one conductive agent [compound (CA)];
ii. reacting the mixture obtained in step i. thereby providing a composition comprising at least one fluoropolymer hybrid organic/inorganic composite [polymer (FH)].

24. The process according to claim 23, wherein step ii. is carried out in the presence of an acid catalyst.

25. A process for the manufacture of a composite electrode [electrode (CE)], said process comprising:
(i) providing a metal substrate having at least one surface;
(ii) providing a composition (C) according to claim 17;
(iii) applying composition (C) provided in step (ii) onto the at least one surface of the metal substrate provided in step (i), thereby providing an assembly comprising a metal substrate coated with said composition (C) onto the at least one surface;
(iv) drying the assembly provided in step (iii);
(v) optionally submitting the dried assembly obtained in step (iv) to a curing step.

26. The process according to claim 25, wherein, under step (iii), the composition (C) is applied onto the metal substrate by any suitable procedures such as casting, printing and roll coating.

27. A composite electrode [electrode (CE)] obtainable by the process according to claim 25, said electrode (CE) comprising:
a metal substrate, and
directly adhered onto at least one surface of said metal substrate, at least one layer [layer (L1)] consisting of a composition (C) comprising:
(i) a fluoropolymer hybrid organic/inorganic composite [polymer (FH)] obtained by the reaction between:
(i-a) at least one functional partially fluorinated fluoropolymer [polymer (FF)] comprising:
recurring units derived from at least one fluorinated monomer [monomer (F)] and
recurring units derived from at least one hydrogenated monomer comprising at least one hydroxyl group [monomer (HM)];
(i-b) at least one compound (M) of formula (I):
X₄₋ₘAYₘ (I)
wherein m is an integer from 1 to 4, A is a metal selected from the group consisting of Si, Ti and Zr, Y is a hydrolysable group and X is a hydrocarbon group, optionally comprising one or more functional groups;
(ii) at least one electro-active compound [compound (EA)];
(iii) at least one organic solvent [solvent (S)]; and
(iv) optionally, at least one conductive agent [compound (CA)].

28. The electrode (CE) according to claim 27 wherein the compound (EA) comprises a carbon-based material and/or a silicon-based material, and the electrode (CE) is a negative composite electrode [electrode (nCE)].

29. The electrode (CE) according to claim 28 wherein the compound (EA) comprises a carbon-based material and a silicon-based material, and the electrode (CE) is a silicon negative composite electrode.

30. An electrochemical device comprising an electrode (CE) according to claim 27.

31. The electrochemical device according to claim 30, said electrochemical device being a secondary battery comprising:
a positive electrode and a negative electrode,
wherein at least one of the positive electrode and the negative electrode is the electrode (CE) and wherein under step (iii), the composition (C) is applied onto the metal substrate by any suitable procedures such as casting, printing and roll coating.

32. The electrochemical device according to claim 31, said electrochemical device being a secondary battery comprising:
a positive electrode and a negative electrode,
wherein the negative electrode is the electrode (CE) and wherein the compound (EA) comprises a carbon-based material and/or a silicon-based material, and the electrode (CE) is a negative composite electrode [electrode (nCE)].
